(19) United States
(12) Patent Application Publication
(10) Pub. No.: US 2006/0272018 A1
(43) Pub. Date: Nov. 30, 2006

(54) Method and apparatus for detecting denial of service attacks

(75) Inventor: Stefan A. Fouant, Herndon, VA (US)

Correspondence Address: VERIZON;PATENT MANAGEMENT GROUP, 1515 N. COURTHOUSE ROAD, SUITE 500, ARLINGTON, VA, 22201-2909, US

(73) Assignee: MCI, Inc., Ashburn, VA (US)

(21) Appl. No.: 11/139,115

(22) Filed: May 27, 2005

(51) Int. Cl. G06F 12/14

(52) U.S. Cl. 726/23

(57) ABSTRACT

An approach is provided for supporting network security. A dataflow destined for an end user network is received. The dataflow is sampled according to a predetermined sampling rate. Flow information is generated from the sampled dataflow. The flow information is forwarded to a collector device for remote behavioral analysis to determine a behavioral profile indicative of a Denial of Service (DoS) attack (e.g., distributed Denial of Service (DDOS) attack) of the end user network.

### FIELD OF THE INVENTION

The present invention relates to data communications, and more particularly, to network security.

### BACKGROUND OF THE INVENTION

The phenomenal growth of the Internet has presented network service providers (e.g., Internet Service Providers (ISPs)) with the continual challenge of responding to the users' demand for reliable, secure, fast and dependable access to this global resource. Satisfying these demands is imperative to maintaining a competitive edge in an intensely competitive market. The vast user base has heightened service providers as well as their customers' susceptibility to security threats. In the past, network security responsibilities have largely been the charge of the end users. However, service providers have come to recognize the commercial viability of offering security services. Undoubtedly, security attacks and breaches impose a heavy cost to both the service providers and their customers.

A particularly troubling type of security concern is the various types of packet flood attacks that negatively impact service availability. Packet flood attacks are a type of denial of service (DoS) attack. A DoS attack is initiated by an attacker to deliberately interfere or disrupt a subscriber's datagram delivery service. A packet flood attack differs from other types of denial of service attacks in that a flood attack requires constant and rapid transmission of packets to the victim in order to be effective. The flood attack overwhelms the victim's connection and consumes precious bandwidth on the service provider's core or backbone networks. Examples of packet flood attacks specific to Unreliable Datagram Delivery Service Networks utilizing IP (Internet Protocol) include ICMP (Internet Control Message Protocol) flood, “SMURF” (or Directed Broadcast Amplified ICMP Flood), “Fraggle” (or Directed Broadcast UDP (User Datagram Protocol) Echo Flood), and TCP (Transmission Control Protocol) SYN flood. These attacks effectively prevent the subscribers from accessing the Internet; in some circumstances, the effects of these attacks may cause a victim host to freeze, thereby requiring a system reboot. In addition to being a nuisance, a system freeze can result in lost of data if precautions were not taken in advance. Because of the severe and direct impact it has on its subscribers, a service provider needs an effective mechanism to detect and prevent or minimize these DoS attacks.

Like many other types of DoS attacks, the attacker can forge the source address of the flood packets without reducing the effectiveness of the attack. Finding the source of forged datagrams in a large, high-speed, unreliable datagram delivery service network is difficult when source-based forwarding decisions are not employed and sufficient capability in most high-speed, high-capacity router implementations is not available. Typically in this case, not enough of the routers in such a network are capable of performing the packet forwarding diagnostics that are required to determine the source. Because the source addresses of the attack packets are almost always forged, it is non-trivial to determine the true origin of such attacks. As a result, tracking down the source of a flood-type denial of service attack is usually difficult or impossible in networks that meet these criteria.

Unfortunately, traditional approaches, e.g., hop-by-hop tracking, to addressing these types of attack utilize highly manual processes. Also, such approaches may require that the routers within the core network assume more traffic processing functions, thereby impeding the forwarding of legitimate traffic.

Based on the foregoing, there is a clear need for improved approaches for detecting and mitigating DoS flood attacks.

### SUMMARY OF THE INVENTION

These and other needs are addressed by the present invention, in which an approach for detecting Denial of Service (DoS) attacks is provided.

According to one aspect of the present invention, a method for providing network security is disclosed. The method includes receiving a dataflow destined for an end user network, and sampling the dataflow according to a predetermined sampling rate. The method also includes generating flow information from the sampled dataflow. Further, the method includes forwarding the flow information for remote behavioral analysis to determine a behavioral profile indicative of a denial of service attack of the end user network.

According to another aspect of the present invention, a communication system for providing network security is disclosed. The system includes a router configured to sample a dataflow destined for an end user network according to a predetermined sampling rate and to generate a flow record from the samples. The system also includes a collector device configured to receive the flow information from the router and to determine a behavioral profile indicative of a denial of service attack of the end user network.

According to yet another aspect of the present invention, a networking apparatus for routing dataflows in a transport network is disclosed. The apparatus includes a flow filter and selection logic configured to sample a dataflow destined for an end user host or network according to a predetermined sampling rate. The apparatus also includes a routing engine configured to route the dataflow over the transport network. Further, the apparatus includes a flow record generator configured to generate flow information from the sampled dataflow for behavioral analysis to detect a denial of service attack of the end user host or network.

Still other aspects, features, and advantages of the present invention are readily apparent from the following detailed description, simply by illustrating a number of particular embodiments and implementations, including the best mode contemplated for carrying out the present invention. The present invention is also capable of other and different embodiments, and its several details can be modified in various obvious respects, all without departing from the spirit and scope of the present invention. Accordingly, the drawing and description are to be regarded as illustrative in nature, and not as restrictive.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a diagram of a communication system capable of detecting Denial of Service (DoS) attacks, according to an embodiment of the present invention;

FIG. 2 is a diagram of a network architecture including an aggregation layer for providing behavioral and statistical analysis of data flows, according to an embodiment of the present invention;

FIG. 3 is a flowchart of a process for detecting DoS attacks, according to an embodiment of the present invention;

FIG. 4 is a diagram of an exemplary router for providing flow filtering and selection, according to an embodiment of the present invention;

FIG. 5 is a flowchart of a process for sampling data flows, according to an embodiment of the present invention;

FIG. 6 is a diagram of a flow record used for behavioral and statistical analysis, according to an embodiment of the present invention;

FIG. 7 is a diagram of data centers for providing flow analysis in support of DoS attack detection according to an embodiment of the present invention; and

FIG. 8 is a diagram of a computer system that can be used to implement an embodiment of the present invention.

### DESCRIPTION OF THE PREFERRED EMBODIMENT

An apparatus, method, and software for detecting Denial of Service (DoS) attacks are described. In the following description, for the purposes of explanation, numerous specific details are set forth in order to provide a thorough understanding of the present invention. It is apparent, however, to one skilled in the art that the present invention may be practiced without these specific details or with an equivalent arrangement. In other instances, well-known structures and devices are shown in block diagram form in order to avoid unnecessarily obscuring the present invention.

Although the various embodiments of the present invention are described with respect to Distributed DoS attacks and the global Internet, it is contemplated that these embodiments have applicability to other security threats and data networks.

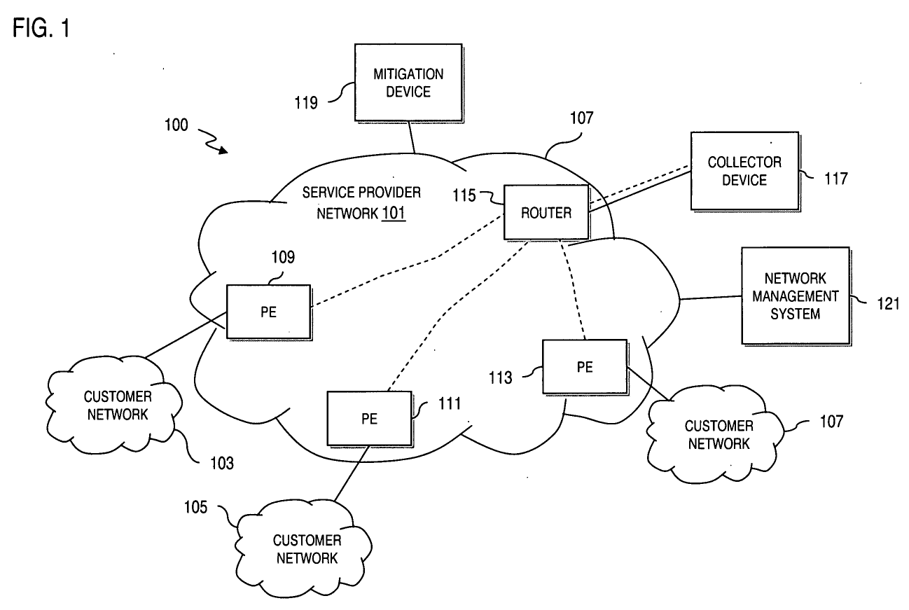

FIG. 1 is a diagram of a communication system capable of detecting Denial of Service (DoS) attacks, according to an embodiment of the present invention. A communication system 100 includes a transport network 101 operated by a service provider. The network 101 serves customer networks 103, 105, 107 via Provider Edge (PE) devices 109, 111, 113, respectively. By way of example, the PE devices 109, 111, 113 are edge routers in communication with a transit router 115 (of which only one is shown).

The service provider network 101, among other telecommunication services, can support a data transport service utilizing, for example, multilayer switching to integrate Layer 2 switching and Layer 3 routing. As used herein, Layer 2 and Layer 3 refer to the Open System Interconnection (OSI) model or other equivalent models. Multilayer switching, in an exemplary embodiment, can employ according to the Multiprotocol Label Switching (MPLS) protocol as specified by the Internet Engineering Task Force (IETF). The network 101 provides an infrastructure for efficiently detecting and mitigating DoS types of attacks, in particular Distributed DoS. To better appreciate the detection services of the network 101, it is instructive to understand the complexity of DDoS attacks.

It is recognized that the trend towards dependence on information and communications systems is accelerating rather than slowing down—as is the gap between the security challenges and the awareness of them. In fact, with the expansion and growth of technology, simple dependence is evolving into interdependence. What happens to one system now has the potential to affect operations on myriad other systems that may only be peripherally related to the target of the initial intrusion. As the dependence on information systems accelerates, so do the attacks which target these systems, which can be critical. According to the Computer Emergency Response Team (CERT) Security Threat Evolution model, the Distributed Denial of Service (DDoS) attack is one of the most complex forms of attack to evolve, and likewise one of the most difficult to defend against. DDoS attacks are a real and growing-threat to businesses and other organizations worldwide. Designed to elude detection, these attacks can quickly incapacitate a targeted business, causing significant loss in revenue and productivity. Notably, DDoS attacks paralyze Internet systems by overwhelming servers, network links, and network devices (routers, firewalls, etc.) with bogus or “bad” traffic. Easily launched against limited defenses, DDoS attacks not only target individual Websites or other servers at the edge of the network—they subdue the network itself.

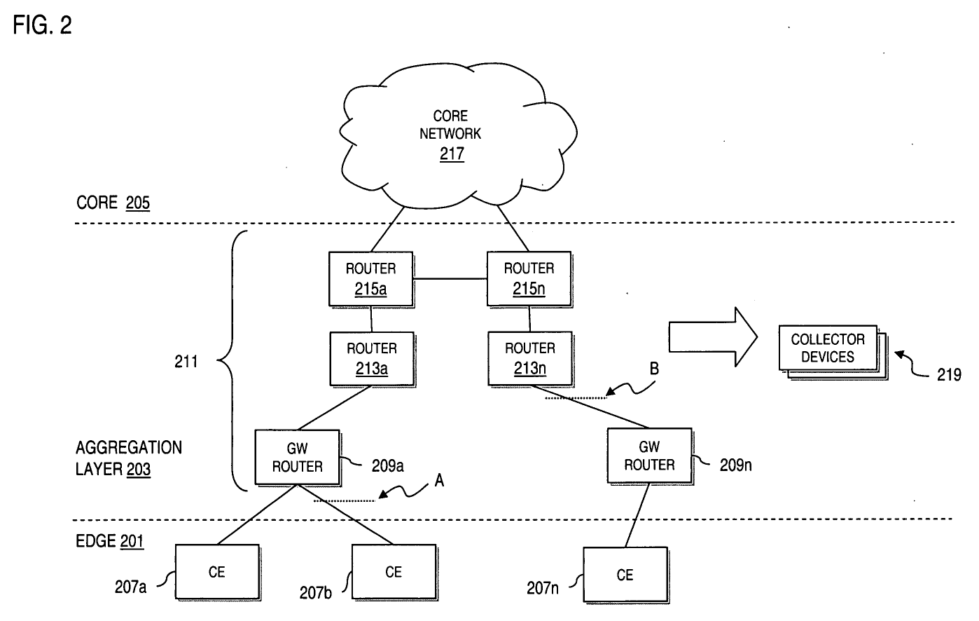

Unfortunately, newer, more powerful DDoS tools are being continually developed to unleash ever more destructive attacks. Because DDoS attacks are among the most difficult to defend against, responding to them appropriately and effectively poses a tremendous challenge for all Internet-dependent organizations. Although important to the overall security strategy, traditional perimeter security technologies such as firewalls and intrusion detection systems (IDSs) do not by themselves provide comprehensive DDoS protection. Instead, defending against a DDoS onslaught that threatens network (e.g., Internet) availability requires a purpose-built architecture that includes the ability to specifically detect and defeat increasingly sophisticated, complex, and deceptive attacks. Such an architecture is more fully described later in FIG. 2.

Clearly, businesses must take steps to protect themselves from these malicious attacks by shoring up defenses at their multiple points of vulnerability. DDoS attacks work by exploiting the communication protocols (e.g., Transmission Control Protocol/Internet Protocol (TCP/IP) suite) responsible for transport the data reliably over the Internet. These attacks also take advantage of the fundamental benefit of the data delivery mechanism—i.e., delivery data packets from nearly any source to any destination without prejudice. Essentially, it is the behavior of these packets that defines the DDoS attack: either there are too many, overwhelming network devices as well as servers, or they are deliberately incomplete to rapidly consume server resources. The difficulty in detecting and mitigating DDoS attacks lies in the fact that illegitimate packets are indistinguishable from legitimate packets. Thus, typical “signature“pattern matching, performed by intrusion detection systems, are ineffective. Many of these attacks also use spoofed source IP addresses, thereby eluding source identification by anomaly-based monitoring tools scanning for unusually high volumes of traffic coming from specific origins. A growing trend among DDoS attackers is to use sophisticated spoofing techniques and essential protocols (instead of nonessential protocols that can be blocked) to make DDoS attacks even more stealthy and disruptive. Undoubtedly, these attacks, which use legitimate application protocols and services, are very difficult to identify and defeat; employing packet-filtering or rate-limiting measures simply aids in the attacker's goal of denying services (e.g., access to network resources) to legitimate users.

The system 100, according to one embodiment of the present invention, supports Distributed Denial of Service (DDoS) mitigation and detection services through the use of a collector device (CD) 705 and a mitigation device 119, in conjunction with the router 115. The mitigation device 119 performs activities to counteract the attack by blocking or otherwise reducing malicious and suspicious traffic. Mitigation schemes can include traceback, pushback, ingress filtering, etc. As used herein, the terms “flow collector” and “flow collection point” are synonymous with the collector device 705. The system 100 permits outbound flows (that are flowing towards a customer) to be sampled and sent to the collector device 705, where analysis can be performed and alerts can be sent in the event the customer is the victim of a DDoS attack. These mitigation and detection services can be implemented based on various arrangements, independent of or in conjunction with a network management system 121.

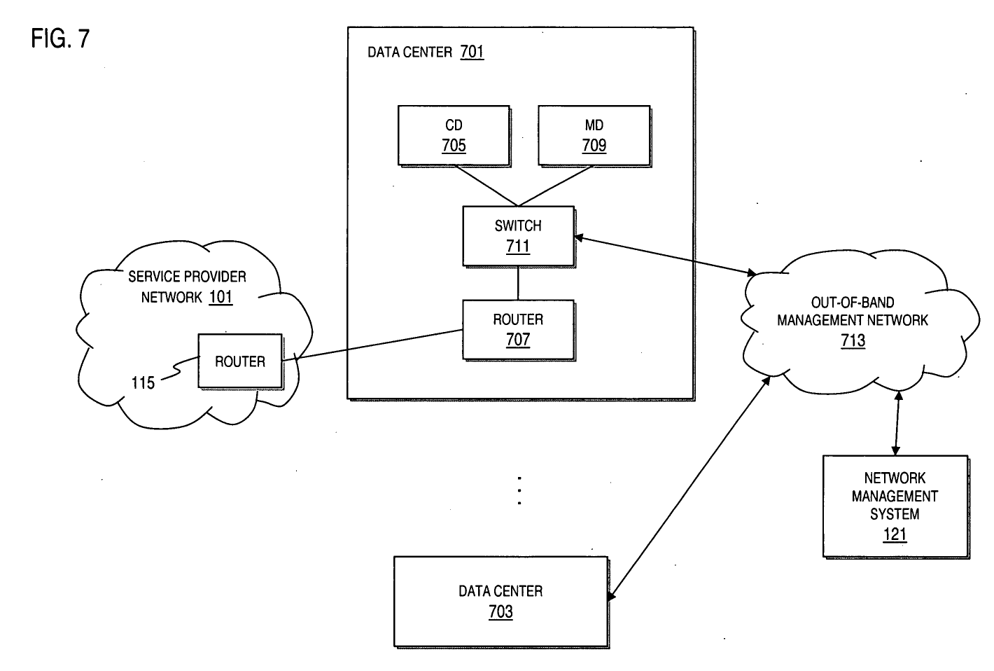

According to one embodiment of the present invention, the collector device 705 and the mitigation device 119 reside within a data center (shown in FIG. 7) operated by a service provider. In accordance with another embodiment of the present invention, the DDoS detection services can be layered on top of existing mitigation services, offering the customer a more intelligent assessment of their traffic flows with an immediate automated notification of anomaly events. In yet another embodiment of the present invention, the DDoS mitigation and detection services are integrated into the service provider network 101 without having the functionality reside in the data centers.

In a traditional environment without specific techniques in place to detect Distributed Denial of Service (DDoS) attacks, all traffic destined for a customer (e.g., customer network 103) flows natively towards that customer. The customer network 103 receives both good (or legitimate) traffic and bad traffic in such a situation. As mentioned, conventionally, the determination as to whether a customer network 103 (or host) is under attack is largely a manual process. Initial detection is usually in the form of services being unavailable because critical systems are under attack, which begins a very tedious process of determining why those critical systems are unavailable. This determination can be very time consuming as it may be extremely difficult to diagnose the problem, which can stem from any number of sources, e.g., at the customer network 103, between the service provider network 101 and a CE 109, or even the service provider network 101 itself.

FIG. 2 is a diagram of a network architecture including an aggregation layer for providing behavioral and statistical analysis of data flows, according to an embodiment of the present invention. The system 100, in an exemplary embodiment, can be implemented as multi-tiered architecture including an edge 201, an aggregation layer 203, and a core 205. DDoS detection services are supplied through this multi-tiered architecture, which provides collection of customer traffic data at the edge of the network through actual or de facto standards based methods (such as NetFlow™ by Cisco Systems or CFlowD by the Cooperative Association for Internet Data Analysis (CAIDA)). These methods provide reporting of flow information in the form of a flow detail records (FDR) back to a flow collection device, in which further processing of the flow data for behavioral analysis is executed. Behavioral analysis involves collecting statistical information to develop usage patterns or trends in the dataflow, whereby deviations from historical patterns (baseline patterns) are noted. For example, real-time and historical statistical data of network activity are captured; such data are utilized to model the behavior of the end users, applications, and network resources for establishment of a “normal” pattern. This “normal” pattern is then used as a baseline to detect anomalous behavior or network misuse.

The edge 201 comprises network elements that interface the customer network (e.g., customer networks 103, 105, 107) with the aggregation layer 203. These network elements include CE devices 207a, 207n, which typically are routers within the customer's network (e.g., networks 103, 105 and 107). It is noted that the CE devices 207a, 207n, in an exemplary embodiment, can be supplied by the service provider. Within the aggregation layer 203 is a routing network 211, which comprises GW routers 209 and transit routers 213a, 213n, 215a, 215n. According to one embodiment of the present invention, the routing network 211 supports label switching (e.g., MPLS). The transit routers 215a, 215n provide connectivity to a core network 217. Alternatively, the routing network 211 can execute the Interior Gateway Protocol (IGP) for the exchange of routing information; examples of IGP include Routing Information Protocol (RIP) and Open Shortest Path First (OSPF). RIP and OSPF are more fully described, respectively, in Internet Engineering Task Force (IETF) Request for Comment (RFC) 1058 and RFC 1583, which are incorporated herein by reference in their entireties. With RIP, routers periodically exchange their entire tables, while OSPF performs link-state algorithms to populate routing information and requires only the exchange of portions of such tables.

At the aggregation layer 203, one or more collector devices 219 are utilized to support the DDoS detection techniques, which allow for analysis, identification, reporting, and alert functions to be offered for anomalies in the customer's traffic. Through this service, the customer can be notified immediately that they are a victim of such an attack, which can spare the customer the long and tedious process of determining the source of the attack, thereby enabling them to focus on attack remediation—potentially saving the victim large amounts of lost revenue.

In an exemplary embodiment of the present invention, the detection service as provided by the collector device 705 uses statistical and behavioral analysis methods, rather than signature based analysis methods. For example, the collector device 705 can be based on the Arbor® Networks Peakflow MS product. The collector device 705 can advantageously detect zero-day attacks—which signature based systems are unable to detect.

The device 705 can also create behavioral profiles to establish a baseline for the customers' “normal” traffic pattern. That is, by building profiles of customer's “normal” traffic habits, to the collector device 705 can readily detect attacks when a customer's traffic is out-of-profile. The collector device 705 can also be loaded with built-in or default profiles of common attacks, which are independent of a customer's “normal” habits.

Two approaches for data collection are considered. The first method is where the flow information is gathered at the aggregation layer 203 on the router 213 as traffic is traversing it towards the customer. This method allows for higher scalability, massive distribution of the service, and reduces the cost to implement the service. The second method allows for flow information to be gathered on the GW router 209n at the output towards the customer. This approach allows for simplistic capturing of the customer's flow information and can be an alternative approach in the event that the first approach cannot be used. Thus, the customer traffic can be collected at point A between the GW router 209a (in the later approach) and the CE 207n or at point B between the GW router 209n and the transit router 213n (in the former approach).

When a customer's traffic is out-of-profile, or when a common attack is detected, the collector device 705 generates one or more alerts. Alerts can be sent via a number of mechanisms, such as email, pager, Simple Network Management Protocol (SNMP) traps, or Syslog. Anomalies can be rated as high, medium or low, depending on customer link speed and configured thresholds. In one embodiment of the present invention, the DDoS mitigation and detection service can update filters dynamically on the mitigation device 119 or cause a triggered mitigation to take place.

The CDs 219, in an exemplary embodiment, are configured to receive Border Gateway Protocol (BGP) information from the routing network 211. BGP is an exterior routing protocol used for IP-based networks, such as the global Internet. The protocol performs three types of routing: interautonomous system routing, intra-autonomous system routing, and pass-through autonomous system routing. BGP is further detailed in RFCs 1771, 1772, 1774 and 1657, which are incorporated herein by reference in their entireties.

The CDs 219 utilize the real-time marriage of BGP to flow information to automatically detect interface behavior, including peers and customers associated with the interfaces. The CDs 219 also provide fine-grain mapping of traffic-to-BGP path information (e.g., Autonomous System Numbers (ASNs), next hops, communities, etc.). With the BGP information, the CDs 219 can accurately distinguish between types of flows (in, out, backbone, etc.) across each interface. In addition, the CDs 219 can provide real-time alerting upon significant changes in interface and network behavior (e.g., a peer begins defaulting to you or a peer begins massive pre-pending of announcements). Further, the CDs 219 can assist in the traceback process by providing identification of the source or ingress of attacks.

Under this architecture, the CDs 219 are deployed within their own SubAS. If CDs 219 participated in the same SubAS as the routing network 211 from which they are receiving flow information, the CDs 219 may not receive full route information—unless they peered with each device within the SubAS, as per iBGP full mesh rules. This approach achieves the desirable goals of having visibility into confederation member SubASes, and eliminates the need for iBGP full mesh. Each router that is generating flow information will eiBGP (commonly referred to as cBGP or confederation BGP) peer with their respective CD with which they are sending flow information.

Furthermore, the CDs 219 can combine real-time BGP, NetFlow, and SNMP information to provide detailed information about the traffic traversing a particular customer network. SNMP settings are used by the CD 219 to provide information about router interfaces (such as names and descriptions) in, for example, a web user interface. Consequently, the router that generates the flow information will allow for SNMP polling from the associated CD 219.

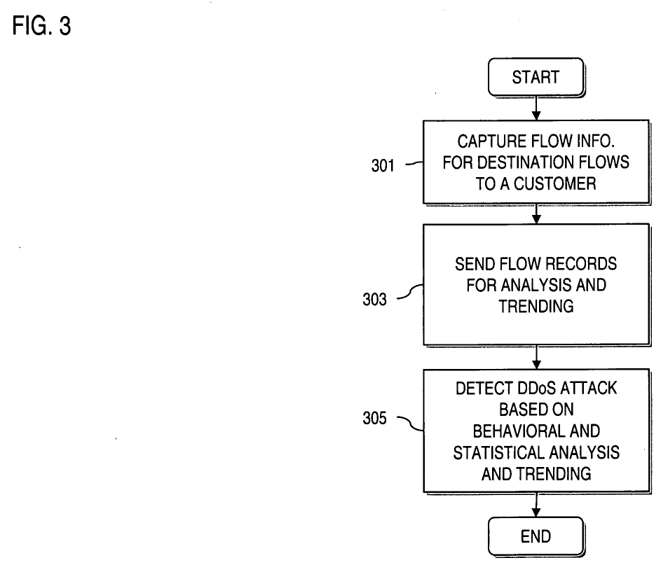

FIG. 3 is a flowchart of a process for detecting DoS attacks, according to an embodiment of the present invention. For the purposes of illustration, this process is explained with respect to the system of FIG. 2. In step 301, flow information is captured for destination flows to the customer. This step 301 involves the use of various flow sampling mechanisms at the aggregation layer 203 of the network 101, which effectively captures relevant flow information associated with the customer requesting the service and builds a flow record (e.g., flow detail record). Next, the flow records after they have been processed are sent to the collector device 219 (step 303), whereby further analysis and trending can be performed on the data, as in step 305.

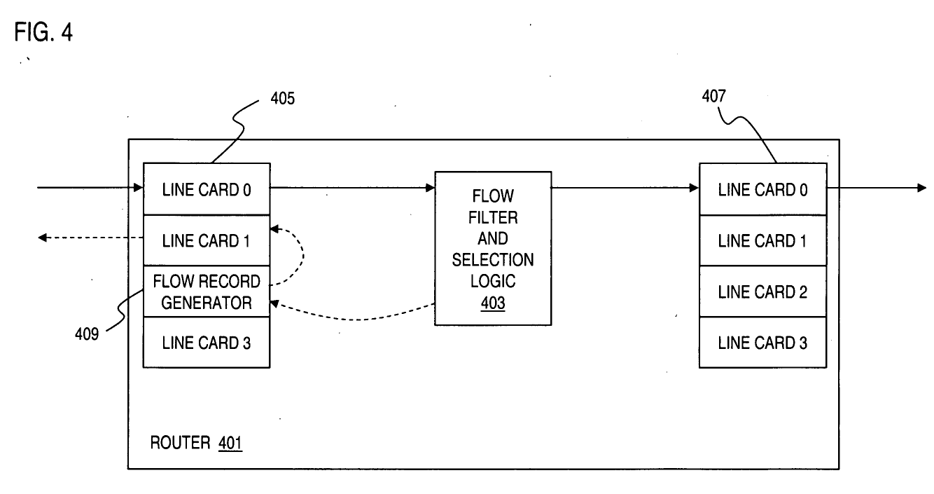

FIG. 4 is a diagram of an exemplary router for providing flow filtering and selection, according to an embodiment of the present invention. A router 401 serves as a flow collection point for network security services. In an exemplary embodiment, the router 401 includes a flow filter and selection logic 403 for sampling dataflows. The router 401 utilizes a variety of physical interfaces 405, 407 to communicate with other network devices. These interfaces 405, 407 can be in the form of line cards.

In this exemplary scenario, the sampling is performed at the transit router (e.g., router 213), a data flow enters the interface 405 at Line Card 0 and is received by the flow filter and selection logic 403, which samples the data flow according to a predetermined rate and criteria. This logic 403 filters (or selects) the data flow for further processing by a flow record generator 409. According to one embodiment of the present invention, it is contemplated that the router 401 be deployed as an infrastructure device; consequently, the router 409 processes a large amount of regional and metro traffic, thereby requiring the capability to separate the flows destined for a given customer from the rest of the traffic traversing the device 409. To perform such a separation, the flow filter and selection logic 403 is configured with a firewall filter to match on destination flows to the customer, Classless Inter-domain Routing (CIDR) block or host address. As the packets enters the router 401, the logic 403 filters traffic and finds a match on a destination CIDR block or host address, selects flows based on the configured sampling rate (e.g., 1 in 100), and sends the sampled packets to the flow record generator 409 for further processing.

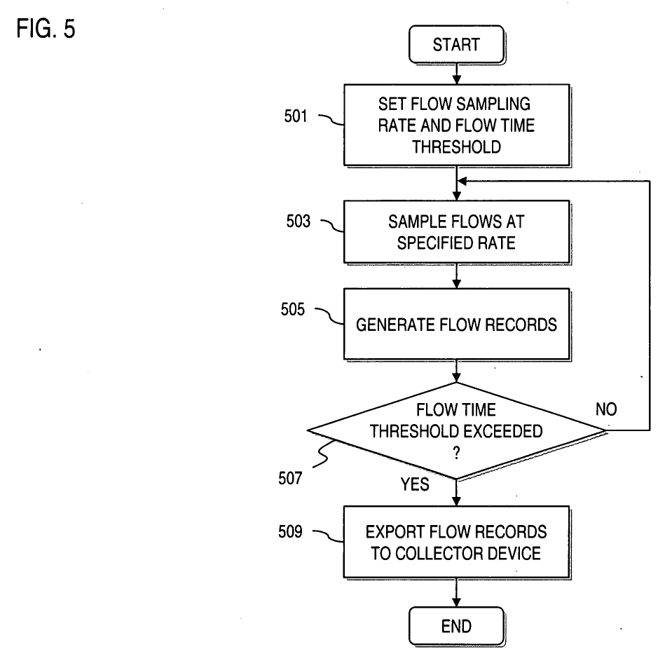

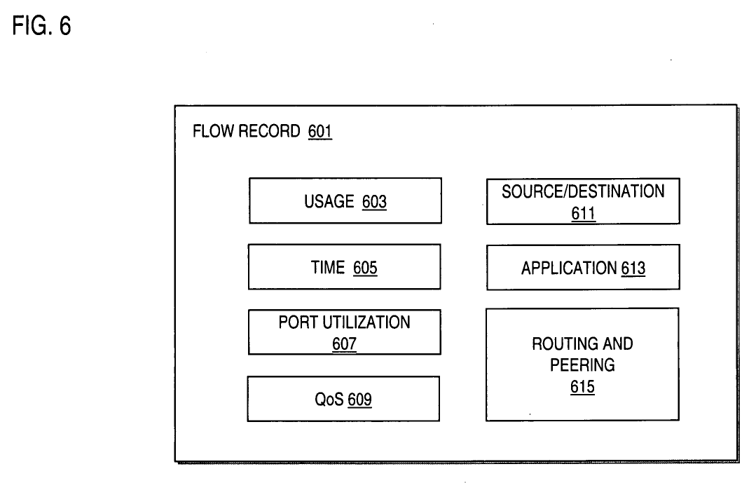

The flow record generator 409 creates flow records (as shown in FIG. 6), which are then forwarded to the collector device 117 (in FIG. 1) for analysis via Line Card 1, for instance. That is, the packaging of the flow records, which can be any standard format (e.g., CFlowD), is performed on the generator 409, thereby alleviating the processing burden associated with the sampling process from the routing engine of the router 401. This sampling process is explained below with respect to FIG. 5.

In an alternative embodiment, the data flows are sampled at the GW router 209 (FIG. 2). As these devices 209 are closest to the customer, the only flows which should traverse this interface are customer specific flows. Therefore, there is no need to configure any type of filtering of select flows to parse and send to the sampled process. As packets egress this interface destined towards the customer, all of the packets are sampled based on the configured sampling rate (e.g., 1 in 100), resulting in flow records (e.g., NetFlow records). The packaging of the flow records is performed on the flow record generator 409 of the router 401. As noted, this approach is beneficial for its simplistic approach to capturing the customer's flow information.

FIG. 5 is a flowchart of a process for sampling data flows, according to an embodiment of the present invention. High traffic volume necessitates the ability to record flow information from a small fraction of the packets, which is known generically as “sampling.” By way of example, all traffic are sampled at a configurable rate—e.g., of 1 in 100 packets. It is noted that different sampling rates can be applied to different data flows, depending on the requirements of the behavioral and statistical analysis. While it might seem counterintuitive to sample at such a small rate in order to detect attacks, statistics have shown this sampling process to be highly accurate especially when allowed to run for long periods of time.

In step 501, the flow sampling rate is set. Additionally, a flow time threshold is also set to specify the sampling interval. The flows are then sampled according to the specified rate, per step 503. Flow records are then generated by the flow record generator 409, as in step 505. The process then determines whether the flow time threshold is exceeded, as in step 507. If the threshold is exceeded, the flow records are exported to the collector device 117 (step 509). Once collected, flow records are kept locally on the router 401, and are periodically exported, for example, via User Datagram Protocol (UDP) to the collector device 117, based on configurable timeouts. In other words, after flows are collected, and active or inactive flow timeout thresholds have expired, the flow records are forwarded.

An exemplary format of a flow record is now described below in FIG. 6.

FIG. 6 is a diagram of a flow record used for behavioral and statistical analysis, according to an embodiment of the present invention. The flow collection and sampling process involves a network device, e.g., a router, recording certain information about the packets that traverse an interface. For the purposes of DDoS detection, these capabilities are utilized to gather information regarding flows towards a given customer. Packets having similar characteristics can be grouped together in a flow. According to an exemplary embodiment, a “flow” is defined as a set of packets that have one or more of the following parameters (as enumerated in Table 1) in common:

TABLE 1

| Parameter | Description |
|---|---|
| Source network address | Network address of network |
| | device originating traffic (e.g., IP |
| | v4 or IP v6 address) |
| Destination network address | Network address of network |
| | device where traffic terminates |
| | (e.g., IP v4 or IP v6 address) |
| Source port number | Port number of network device |
| | originating traffic |
| Destination port number | Port number of network device |
| | terminating traffic |
| Layer 3 protocol type | Layer 3 protocol supported |
| ToS byte | Type-of-Service specifying |
| | priority and handling |
| Input logical interface | Identifier of the input interface |

The ToS Byte is contained in an IP datagram for specifying the IP support for prioritization and Type-of-Service handling, and includes three fields: the “Precedence field” for prioritizing the IP Datagram; a “Type-of-Service” field for describing how the network should make tradeoffs between throughput, delay, reliability, and cost in routing an IP Datagram; and a “MBZ” (must be zero) field that is unused and must be zero. The ToS byte is further described in IETF Request for Comment (RFC) 1349, which is incorporated herein by reference in its entirety.

In an exemplary embodiment, all of the packets that share some of the characteristics in Table 1 are combined into one flow record, along with additional information regarding these flows such as the source and destination AS (Autonomous System), TCP Flags, etc. A diagram showing the fields populated in a flow record is shown in FIG. 6, in accordance with NetFlow v5/CFlowD v5 Flow Record.

A flow record 601 includes a Usage field 603 for specifying the packet count and byte count. A Time field 605 can include a start and end times (e.g., start sysUp time and end sysUp time). The record 601 also has a Port Utilization field 607 specifies, for instance, an input interface index and an output interface index. A QoS field 609 specifies the Type of Service, TCP flags, and protocol. A source and destination field 611 indicates the source P address and the destination IP address. Additionally, the flow record 601 can include an Application field 613 that specifies a source port (e.g., TCP/UDP port) and a destination port (e.g., TCP/UDP port). Further, the Routing and Peering field 615 can indicate routing related information, such as next hop address, source AS number, destination AS number, source prefix mask, and destination prefix mask.

FIG. 7 is a diagram of data centers for providing flow analysis in support of DoS attack detection, according to an embodiment of the present invention. Under this scenario, the data centers 701, 703 can be used for placement of a collector device 705, allowing for a regionalized distribution of collection points.

The collector device 705 can proactively detect infrastructure security threats and automate the traceback and remediation process. In an exemplary embodiment, a single collector device can process flow information from many devices in the network 101. Operating together, multiple collector devices 705 can incrementally scale to support very large networks, delivering an extensible solution that easily adapts to large and growing environments.

Certain routers (e.g., router 115) in the service provider network 101 can be configured to capture relevant flow information and forward this data via a router 707 in the form of a flow record to the collector device 705. As described early, the collector device 705 processes and stores this flow information, as well as well as provide a web-based portal for customers that seek visibility into their traffic.

Also, in an exemplary embodiment, the CD 705 may communicate with the MDs 709 in the data center 701 to update filters on the MDs 709 for blocking malicious or suspicious traffic. Although the MDs 709 are shown as collocated with the collector device 705, it is recognized that the MDs 709 can be remotely situated from the collector device 705.

In this example, the CD 705 can be connected to one or more switches 711 in the data centers, and will appear logically as being adjacent to existing MDs 709, as shown FIG. 7. In addition, flow information can be generated from select routers (within the service provider network 101) which process flows destined for specific customers that require this service.

According to an exemplary embodiment, within each data center 701, 703, the CD 705 can terminate via, for instance, a single Gigabit Ethernet interface into the switch 711. In addition, the CD 705 can communicate over an Out-Of-Band (OOB) Management Network 713 for the purposes of out-of-band management of the devices within the data center 701.

In accordance with one embodiment of the present invention, the communication among the CD 705 and the MDs 709 are through the switch 711 using Virtual Local Area Networks (VLANs) for Layer 2 connectivity. For example, the MDs 709 can reside on different VLANs. The CD 705 within the data center 701 configured as such. The traffic from the CD 705 may need to traverse a Layer 3 hop via the router 707 to reach the alternate VLAN.

The Out-Of-Band (OOB) Management Network 713 provides uninterrupted connectivity to all network devices and ensures that access to these devices will not be affected by any disturbances in Layer 2 switching or Layer 3 routing infrastructure. The OOB Management Network 713 is used to manage the various layers of routers, switches, firewalls, and other devices deployed within the data center 701 when in-band connectivity to these devices is unavailable.

The above detection and mitigation services supported by the system 100 advantageously provide an automated and effective approach to addressing DoS attacks, such as DDoS attacks.

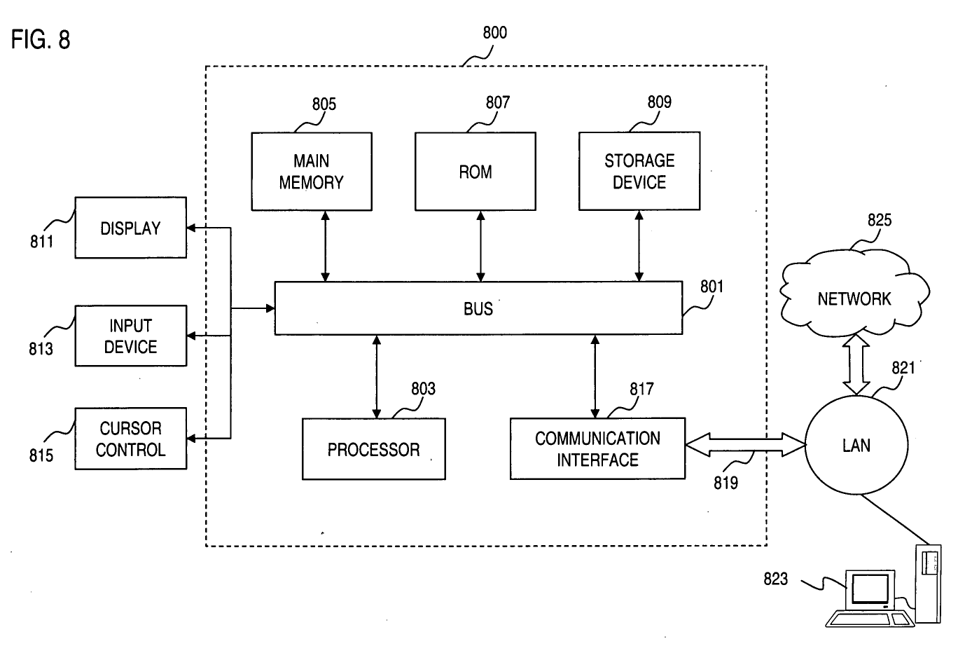

FIG. 8 illustrates a computer system 800 upon which an embodiment according to the present invention can be implemented. For example, the processes of FIGS. 3 and 5 can be implemented using the computer system 800. The computer system 800 includes a bus 801 or other communication mechanism for communicating information and a processor 803 coupled to the bus 801 for processing information. The computer system 800 also includes main memory 805, such as a random access memory (RAM) or other dynamic storage device, coupled to the bus 801 for storing information and instructions to be executed by the processor 803. Main memory 805 can also be used for storing temporary variables or other intermediate information during execution of instructions by the processor 803. The computer system 800 may further include a read only memory (ROM) 807 or other static storage device coupled to the bus 801 for storing static information and instructions for the processor 803. A storage device 809, such as a magnetic disk or optical disk, is coupled to the bus 801 for persistently storing information and instructions.

The computer system 800 may be coupled via the bus 801 to a display 811, such as a cathode ray tube (CRT), liquid crystal display, active matrix display, or plasma display, for displaying information to a computer user. An input device 813, such as a keyboard including alphanumeric and other keys, is coupled to the bus 801 for communicating information and command selections to the processor 803. Another type of user input device is a cursor control 815, such as a mouse, a trackball, or cursor direction keys, for communicating direction information and command selections to the processor 803 and for controlling cursor movement on the display 811.

According to one embodiment of the invention, the sampling and detection processes are performed by the computer system 800, in response to the processor 803 executing an arrangement of instructions contained in main memory 805. Such instructions can be read into main memory 805 from another computer-readable medium, such as the storage device 809. Execution of the arrangement of instructions contained in main memory 805 causes the processor 803 to perform the process steps described herein. One or more processors in a multi-processing arrangement may also be employed to execute the instructions contained in main memory 805. In alternative embodiments, hard-wired circuitry may be used in place of or in combination with software instructions to implement the embodiment of the present invention. Thus, embodiments of the present invention are not limited to any specific combination of hardware circuitry and software.

The computer system 800 also includes a communication interface 817 coupled to bus 801. The communication interface 817 provides a two-way data communication coupling to a network link 819 connected to a local network 821. For example, the communication interface 817 may be a digital subscriber line (DSL) card or modem, an integrated services digital network (ISDN) card, a cable modem, a telephone modem, or any other communication interface to provide a data communication connection to a corresponding type of communication line. As another example, communication interface 817 may be a local area network (LAN) card (e.g. for Ethernet™ or an Asynchronous Transfer Model (ATM) network) to provide a data communication connection to a compatible LAN. Wireless links can also be implemented. In any such implementation, communication interface 817 sends and receives electrical, electromagnetic, or optical signals that carry digital data streams representing various types of information. Further, the communication interface 817 can include peripheral interface devices, such as a Universal Serial Bus (USB) interface, a PCMCIA (Personal Computer Memory Card International Association) interface, etc. Although a single communication interface 817 is depicted in FIG. 8, multiple communication interfaces can also be employed.

The network link 819 typically provides data communication through one or more networks to other data devices. For example, the network link 819 may provide a connection through local network 821 to a host computer 823, which has connectivity to a network 825 (e.g. a wide area network (WAN) or the global packet data communication network now commonly referred to as the “Internet“) or to data equipment operated by a service provider. The local network 821 and the network 825 both use electrical, electromagnetic, or optical signals to convey information and instructions. The signals through the various networks and the signals on the network link 819 and through the communication interface 817, which communicate digital data with the computer system 800, are exemplary forms of carrier waves bearing the information and instructions.

The computer system 800 can send messages and receive data, including program code, through the network(s), the network link 819, and the communication interface 817. In the Internet example, a server (not shown) might transmit requested code belonging to an application program for implementing an embodiment of the present invention through the network 825, the local network 821 and the communication interface 817. The processor 803 may execute the transmitted code while being received and/or store the code in the storage device 809, or other non-volatile storage for later execution. In this manner, the computer system 800 may obtain application code in the form of a carrier wave.

The term “computer-readable medium” as used herein refers to any medium that participates in providing instructions to the processor 803 for execution. Such a medium may take many forms, including but not limited to non-volatile media, volatile media, and transmission media. Non-volatile media include, for example, optical or magnetic disks, such as the storage device 809. Volatile media include dynamic memory, such as main memory 805. Transmission media include coaxial cables, copper wire and fiber optics, including the wires that comprise the bus 801. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the present invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

While the present invention has been described in connection with a number of embodiments and implementations, the present invention is not so limited but covers various obvious modifications and equivalent arrangements, which fall within the purview of the appended claims.

What is claimed is:

1. A method for providing network security, the method comprising the steps of:
receiving a dataflow destined for an end user network;
sampling the dataflow according to a predetermined sampling rate;
generating flow information from the sampled dataflow; and
forwarding the flow information for remote behavioral analysis to determine a behavioral profile indicative of a denial of service attack of the end user network.

2. A method according to claim 1, wherein the dataflow is assigned a label associated with a Layer 2 path within a transport network, the method further comprising the steps of:
removing the label from the dataflow;
examining a Layer 3 address associated with the dataflow; and
routing the dataflow over the transport network according to the end user network according to the Layer 3 address.

3. A method according to claim 2, wherein the behavioral analysis is performed at a collector device, the collector device comparing the behavioral profile against a baseline profile.

4. A method according to claim 3, wherein the collector device resides in a data center for serving a plurality of end user networks.

5. A method according to claim 3, further comprising the step of:
initiating blocking, at a mitigation device, of a subsequent dataflow destined for the end user network in response to the determination of the behavioral profile by the collector device.

6. A method according to claim 5, wherein the mitigation device is configured to receive filter parameters from the collector device for blocking of the subsequent dataflow.

7. A method according to claim 2, wherein the routing step is executed according to an Interior Gateway Protocol (IGP) or Multiprotocol Label Switching (MPLS) protocol.

8. A method according to claim 1, wherein the denial of service attack is a distributed attack.

9. A communication system for providing network security, comprising:
a router configured to sample a dataflow destined for an end user network according to a predetermined sampling rate and to generate a flow record from the samples; and
a collector device configured to receive the flow information from the router and to determine a behavioral profile indicative of a denial of service attack of the end user network.

10. A system according to claim 9, wherein the collector device compares the behavioral profile with a baseline profile.

11. A system according to claim 9, wherein the collector device resides in a data center for serving a plurality of end user networks.

12. A system according to claim 9, further comprising:
a mitigation device configured to initiate blocking of a subsequent dataflow destined for the end user network in response to the behavioral profile determined by the collector device.

13. A system according to claim 12, wherein the mitigation device is configured to receive filter parameters from the collector device for blocking of the subsequent dataflow.

14. A system according to claim 11, wherein the router is configured to route according to an Interior Gateway Protocol (IGP) or Multiprotocol Label Switching (MPLS) protocol.

15. A system according to claim 9, wherein the denial of service attack includes a distributed Denial of Service (DDoS) attack.

16. A networking apparatus for routing dataflows in a transport network, the apparatus comprising:
a flow filter and selection logic configured to sample a dataflow destined for an end user host or network according to a predetermined sampling rate;
a routing engine configured to route the dataflow over the transport network; and
a flow record generator configured to generate flow information from the sampled dataflow for behavioral analysis to detect a denial of service attack of the end user host or network.

17. An apparatus according to claim 16, wherein the dataflow is assigned a label associated with a Layer 2 path within the transport network, the apparatus further comprising:
means for removing the label from the dataflow,
wherein the routing engine examines a Layer 3 address associated with the dataflow and routes the dataflow based on the Layer 3 address.

18. An apparatus according to claim 17, wherein the behavioral analysis is performed at a collector device, the collector device determining a behavioral profile based on the sampled dataflow and comparing the behavioral profile against a baseline profile.

19. An apparatus according to claim 18, wherein the collector device resides in a data center for serving a plurality of end user networks.

20. An apparatus according to claim 18, wherein a mitigation device is configured to initiate blocking of a subsequent dataflow destined for the end user host or network in response to the behavioral analysis by the collector device.

21. An apparatus according to claim 20, wherein the mitigation device is configured to receive filter parameters from the collector device for blocking of the subsequent dataflow.

22. An apparatus according to claim 17, wherein the routing engine routes the dataflow according to an Interior Gateway Protocol (IGP) or Multiprotocol Label Switching (MPLS) protocol.

23. An apparatus according to claim 16, wherein the denial of service attack is a distributed attack.
